(19) United States
(12) Patent Application Publication
(10) Pub. No.: US 2005/0036450 A1
(43) Pub. Date: Feb. 17, 2005

(54) Network monitoring system, reproduction terminal, and monitoring terminal

(76) Inventors: Kozue Arimori, Hitachinaka (JP); Takashi Takahashi, Hitachinaka (JP); Toshio Hoshi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/867,654

(22) Filed: Jun. 16, 2004

(30) Foreign Application Priority Data
Jun. 16, 2003 (JP) 2003-170320

(51) Int. Cl. H04L 12/26

(52) U.S. Cl. 370/235; 370/241

(57) ABSTRACT

The network monitoring system includes: a monitoring equipment 10; and a reproduction terminal 20 which decompresses compressed image data included in monitoring information transmitted by the monitoring equipment through a network line 40; a calculation unit for calculating the transmittable amount of information 501 which calculates the transmittable amount of information per unit time of the network line; and a calculation unit for calculating the transmitted amount of information 502 which calculates the transmitted amount of information per unit time of the monitoring information to be transmitted on the basis of a predetermined occupation ratio in order to determine a ratio of the monitoring information to the calculated transmittable amount of information, and the amount of information per unit time of monitoring information to be transmitted from the monitoring equipment is controlled on the basis of the transmitted amount of information per unit time that has been calculated by the calculation unit for calculating the transmitted amount of information.

### CLAIM OF PRIORITY

The present application claims priority from Japanese Application Serial No. 2003-170320, filed on Jun. 16, 2003, the content of which is hereby incorporated by reference into this application.

### BACKGROUND OF THE INVENTION

The present invention relates to a communication system in which communications are made among a plurality of devices through a network line. In particular the present invention relates to a network monitoring system, a reproduction terminal, and a monitoring terminal that collect information from a sensor or a monitoring camera through a network line shared by services of other communication systems.

In general, a monitoring system that uses a network line digitally compresses images and data before transmitting and receiving them as information. Nevertheless, the image data tends to include a large amount of information. In particular, since the higher quality of a monitoring image is required in the event of an emergency, such as at the time of the occurrence of an alarm, it is temporarily necessary to intensively transmit a very large amount of information. Moreover, recently a plurality of monitoring systems have often been connected to one network line. However, as far as the system in which the plurality of monitoring systems are connected to one network line is concerned, the cost of a network system capable of transmitting a large amount of information among terminals becomes high.

In order to solve this problem, in the prior art, monitoring information is classified into two: monitoring information, the transmitted amount of information per unit time of which is kept constant; and monitoring information, the transmitted amount of information per unit time of which can be changed in response to an unoccupied band where the amount of information can be ignored in a network line. Mixing these monitoring information in the same network line makes it possible to effectively use the network line.

To be more specific, the monitoring system is proposed in which, when the amount of information to be transmitted on a network line needs to be increased at the time of the occurrence of an alarm whose transmitted amount of monitoring information is kept constant is first reduced to expand an unoccupied band, and then an alarm image whose transmitted amount of information is expanded is transmitted using the unoccupied band. That is to say, between monitoring systems that use the same network line, the amount of monitoring information occupied in the network line is increased or decreased, i.e., balanced. Thus, the network line is effectively used while guaranteeing the quality of monitoring information. For example, refer to patent document 1 (Japanese Patent Laid-open No. 2000-151710).

In addition, a data communication system is proposed as another prior art in which: the transmittable amount of information per unit time is detected; and the transmitted amount of information per unit time of data to be transmitted from monitoring equipment is changed so that the data can be transmitted at the transmittable amount of information; and thereby an unoccupied band is effectively used. For example, refer to patent document 2 (Japanese Patent Laid-open No. 11-308271).

When a network monitoring system that uses a network line is built, an existing network line where services of other communication systems are provided is often used. In addition, users' needs for utilizing the existing network line are also high.

However, the prior art described in the patent document 1 relates to a dedicated network monitoring system in which equipment that is connected to the network line is specified in advance, so that the transmitted amount of information of each set of equipment can be controlled. This prior art, therefore, does not take into consideration a coexistence method for coexisting with services of the other communication systems, which are provided through one network line. To be more specific, since it is not possible to control the transmitted amount of information of equipment used in the other communication systems, the network line cannot be effectively used. Accordingly, trying to intensively transmit a large amount of information in the event of an emergency, for example, at the time of the occurrence of an alarm, causes inability in services of the other communication systems, or causes the decrease in communication speed.

Moreover, in the prior art described in patent document 2, since the amount of information that is equivalent to the detected transmittable amount of information is transmitted from the monitoring equipment, an unoccupied band is not kept unused. Because of it, however, the following problems are produced: the other communication systems could not start communications when trying to start the communications; and the communication speed is decreased. In particular, in the event of an emergency, such as at the time of the occurrence of an alarm, temporarily a very large amount of information is intensively transmitted to ensure the quality of monitoring information. This causes the inability in services of the other communication systems that use the same network, or causes the decrease in communication speed. Additionally, in this case, when trying to transmit data with the low amount of information, the quality of an image at the time of the alarm gets worse.

An object of the present invention is to provide a network monitoring system, a reproduction terminal, and a monitoring terminal that can improve the quality of communications of the other communication systems.

### SUMMARY OF THE INVENTION

In order to achieve the above-mentioned object, according to one aspect of the present invention, there is provided a network monitoring system that shares a network line with at least another communication system. The network monitoring system comprises:
monitoring equipment including:
   an encoder for compressing image data;
   a data transmission unit for transmitting monitoring information including compressed image data through the network line; and
   an information-amount adjustment unit for adjusting an amount of information per unit time of the monitoring information to be transmitted from the data transmission unit;
a reproduction terminal including:
   a data receiving unit adapted to receive the monitoring information transmitted from the monitoring equipment through the network line; and
   a decoder for decompressing compressed image data included in the monitoring information;
a calculation unit for calculating the transmittable amount of information which calculates the transmittable amount of information per unit time of the network line; and
a calculation unit for calculating the transmitted amount of information which calculates the transmitted amount of information per unit time of the monitoring information to be transmitted on the basis of a predetermined occupation ratio in order to determine a ratio of the monitoring information to the calculated transmittable amount of information;
wherein the information-amount adjustment unit is controlled on the basis of the transmitted amount of information per unit time which has been calculated by the calculation unit for calculating the transmitted amount of information. Thus, providing an unoccupied band in the network line makes it possible to improve the quality of communications of another communication system.

The network monitoring system according to the present invention is characterized in that the information-amount adjustment unit controls the encoder so that the number of images per unit time, the number of picture elements or a compression ratio included in the monitoring information, or their combination may be changed, and thereby the amount of information per unit time of the monitoring information to be transmitted from the data transmission unit is adjusted. This allows compressed image data of an image to be changed so that an unoccupied band is provided in the network line, which makes it possible to improve the quality of communications of another communication system.

According to another aspect of the present invention, there is provided a network monitoring system that shares a network line with at least another communication system. The network monitoring system comprises:
monitoring equipment including:
   an encoder for compressing image data;
   a buffer for accumulating monitoring information including compressed image data compressed by the encoder;
   a data transmission unit which reads out the monitoring information accumulated in the buffer, and then transmits through the network line the monitoring information including compressed image data; and
   an information-amount adjustment unit for adjusting an amount of information per unit time of the monitoring information to be transmitted from the data transmission unit;
a reproduction terminal including:
   a data receiving unit adapted to receive the monitoring information transmitted from the monitoring equipment through the network line; and
   a decoder for decompressing compressed image data included in the monitoring information;
a calculation unit for calculating the transmittable amount of information which calculates the transmittable amount of information per unit time of the network line; and
a calculation unit for calculating the transmitted amount of information which calculates the transmitted amount of information per unit time of the monitoring information to be transmitted on the basis of a predetermined occupation ratio in order to determine a ratio of the monitoring information to the calculated transmittable amount of information;
wherein the information-amount adjustment unit is controlled on the basis of the transmitted amount of information per unit time which has been calculated by the calculation unit for calculating the transmitted amount of information. Thus, the amount of information of transmission data can be changed without changing image compression processing, and providing an unoccupied band in the network line without reducing the image quality makes it possible to transmit monitoring information with high image quality while keeping a proper occupation ratio of the monitoring information in the network line.

The network monitoring system according to the present invention is characterized in that the information-amount adjustment unit controls the encoder so that an image compression ratio per unit time of images included in monitoring information becomes low to increase the number of images, and also controls the data transmission unit so that the amount of information per unit time at the time of reading out images included in the monitoring information accumulated in the buffer may be controlled to adjust the amount of information per unit time of the monitoring information to be transmitted from the data transmission unit. Thus, changing the compressed image data of the image, and thereby providing an unoccupied band in the network line, make it possible to transmit monitoring information with high image quality while keeping a proper occupation ratio of the monitoring information in the network line.

The network monitoring system according to the present invention is characterized in that: the monitoring equipment and the reproduction terminal is each provided with an information transmitting and receiving unit that transmits and receives, between the monitoring equipment and the reproduction terminal, control information used for controlling the network monitoring system; the reproduction terminal is further provided with the calculation unit for calculating the transmittable amount of information and the calculation unit for calculating the transmitted amount of information; and the information transmitting and receiving unit transmits, to the monitoring equipment, information about the transmitted amount of information per unit time that has been calculated by the calculation unit for calculating the transmitted amount of information in the reproduction terminal, and then the monitoring equipment controls the information-amount adjustment unit on the basis of the received information about the transmitted amount of information per unit time. This permits the reproduction terminal to calculate the transmitted amount of information on the basis of an inputted occupation ratio, which eliminates the need for equipping each of the plurality of monitoring equipment with the calculation unit.

The network monitoring system according to the present invention further comprises a unit for achieving date-and-time matching between the reproduction terminal and the monitoring equipment. The calculation unit for calculating the transmittable amount of information, which is provided in the reproduction terminal, calculates the transmittable amount of information per unit time at the time of transmission by the monitoring equipment through the network line, from the transmitted date and time that has been added by the monitoring equipment to each monitoring information to be transmitted by a specified unit of the amount of information, and from the receive completed date and time of the monitoring information received by the reproduction terminal, and the amount of received information. This enables calculation of the actual transmittable amount of information from a period of time until the completion of the transmission by use of information about the specified unit.

The network monitoring system according to the present invention is characterized in that the calculation unit for calculating the transmittable amount of information, which is provided in the reproduction terminal, calculates a transmittable amount of information per unit time at the time of transmission by the monitoring equipment through the network line, from the length of time spent from the transmission of the control information until the receipt of the control information, and from the amount of information. This enables calculation of the actual transmittable amount of information from the length of time spent from the transmission of the control information until the receipt of the control information, and from the amount of information.

The network monitoring system according to the present invention further includes a timer generator. This system is characterized in that every time a given period of time elapses, the calculation unit for calculating the transmittable amount of information calculates the transmittable amount of information per unit time at the time of transmission through the network line; and then the information-amount adjustment unit is controlled on the basis of a transmitted amount of information per unit time, which has been calculated by the calculation unit for calculating the transmitted amount of information from the calculated transmittable amount of information per the unit time and the occupation ratio. This makes it possible to calculate the amount of information of transmit data in accordance with the transmittable amount of information that changes every moment, which improves the efficiency in using the network line.

The network monitoring system according to the present invention is characterized in that the calculation unit for calculating the transmitted amount of information performs the steps of: accumulating a plurality of pieces of information about the transmittable amount of information per unit time sent from the calculation unit for calculating the transmittable amount of information; calculating a degree of change in the plurality of pieces of information about the transmittable amount of information per unit time; every time a given period of time elapses, calculating and accumulating the transmittable amount of information per unit time; and adjusting an amount of monitoring information on the basis of a ratio of the latest transmittable amount of information calculated this time to the transmittable amount of information that has been calculated and accumulated last time. Thus, when the change in the transmittable amount of information is small, processing of calculating the transmittable amount of information becomes unnecessary. In addition, a processing load of transmitting and receiving information between the monitoring equipment and the reproduction terminal is also reduced.

The network monitoring system according to the present invention is characterized in that the monitoring equipment has a plurality of operation modes, changes the occupation ratio in accordance with the operation modes, and thereby adjusts the amount of information per unit time of the monitoring information to be transmitted from the data transmission unit. This makes it possible to change the occupation ratio in accordance with, for example, an image quality mode. In a high image quality mode, increasing the occupation ratio makes it possible to transmit an image with high image quality.

The network monitoring system according to the present invention further includes an alarm generator for generating an alarm if an abnormal condition of a target to be monitored is detected. This system is characterized in that the alarm generator classifies the abnormal condition into a plurality of levels; and one of the operation modes is selected in accordance with one of the levels, and the occupation ratio is changed in accordance with the selected operation mode, whereby the amount of information per unit time of the monitoring information to be transmitted from the data transmission unit is adjusted. This makes it possible to change the occupation ratio according to the level of the abnormal condition. Accordingly, if a level of an abnormal condition is high, it is possible to transmit an image with high image quality.

The network monitoring system according to the present invention further includes an alarm generator for generating an alarm if an abnormal condition of a target to be monitored is detected. This system is characterized in that when an alarm occurs, image monitoring information for a given period of time from the occurrence of the alarm is stored in the buffer for accumulating monitoring information; the amount of information per unit time of the monitoring information to be read out from the buffer is controlled so that a predetermined occupation ratio may be kept unchanged; the amount of information per unit time of the monitoring information to be transmitted from the data transmission unit is adjusted; and all the monitoring information accumulated in the buffer is transmitted. Thus, when an alarm occurs, the amount of information becomes large because of the high image quality; however, the monitoring information is transmitted with the specified occupation ratio being kept unchanged, the difference is temporarily accumulated in the buffer, and the monitoring information accumulated in the buffer as the difference is also transmitted little by little thereafter. Accordingly, it is possible to improve the quality of monitoring information in the event of an emergency.

The network monitoring system according to the present invention is characterized in that, when an alarm occurs, an amount of information per unit time of the monitoring information to be read out from the buffer is controlled; and during normal operation, the number of images per unit time, the number of picture elements, a compression rate, or their combination is changed. During normal operation, the transmitted amount of information is controlled by changing the image quality; and when an alarm occurs, temporarily accumulating monitoring information in the buffer to change the amount of information at the time of reading enables the control of the transmitted amount of information. Thus, providing an unoccupied band in the network line making it possible to improve the quality of communications of another communication system.

According to still another aspect of the present invention, there is provided a reproduction terminal or a monitoring terminal included in a network monitoring system that shares a network line with at least another communication system. The monitoring equipment transmits monitoring information including compressed image data through the network line. The reproduction terminal is adapted to receive the monitoring information transmitted from the monitoring equipment through the network line, and decompresses the compressed image data included in the monitoring information. The reproduction terminal or the monitoring terminal includes: a calculation unit for calculating the transmittable amount of information which calculates the transmittable amount of information per unit time of the network line; and a calculation unit for calculating the transmitted amount of information which calculates the transmitted amount of information per unit time of the monitoring information to be transmitted on the basis of an occupation ratio that has been predetermined, in order to determine a ratio of the monitoring information to the calculated transmittable amount of information; wherein the transmitted amount of information per unit time of the monitoring information to be transmitted from the monitoring equipment can be controlled on the basis of the transmitted amount of information per unit time that has been calculated by the calculation unit for calculating the transmitted amount of information. Thus, providing an unoccupied band in the network line by use of the reproduction terminal or the monitoring terminal makes it possible to improve the quality of communications of the other communication systems.

### BRIEF DESCRIPTION OF THE DRAWINGS

FIG. 1 is a block diagram illustrating a configuration of a network monitoring system according to an embodiment of the present invention;

FIG. 2 is a sequence diagram illustrating information exchanges in the network monitoring system according to the embodiment of the present invention;

FIG. 3 is a timing chart illustrating transmission of monitoring information according to the embodiment of the present invention;

FIG. 4 is a diagram illustrating an occupation image of monitoring information in a network line according to the embodiment of the present invention;

FIG. 5 is a block diagram illustrating a configuration of an information-amount adjustment instruction unit according to the embodiment of the present invention;

FIG. 6 is a block diagram illustrating a configuration of an information-amount adjustment unit according to the embodiment of the present invention;

FIG. 7 is a graph illustrating the change that occurs in response to an operating time period, or the transmittable amount of information, of the system in question, or in response to an alarm level set by a user, according to the embodiment of the present invention;

FIG. 8 is a graph illustrating the change that occurs in response to a processing load of monitoring equipment according to the embodiment of the present invention; and

FIG. 9 is a correspondence table illustrating the correspondence between an encoding compression ratio and the amount of information per image according to the embodiment of the present invention.

### DESCRIPTION OF THE PREFERRED EMBODIMENTS

Preferred embodiments of the present invention will be described with reference to drawings below.

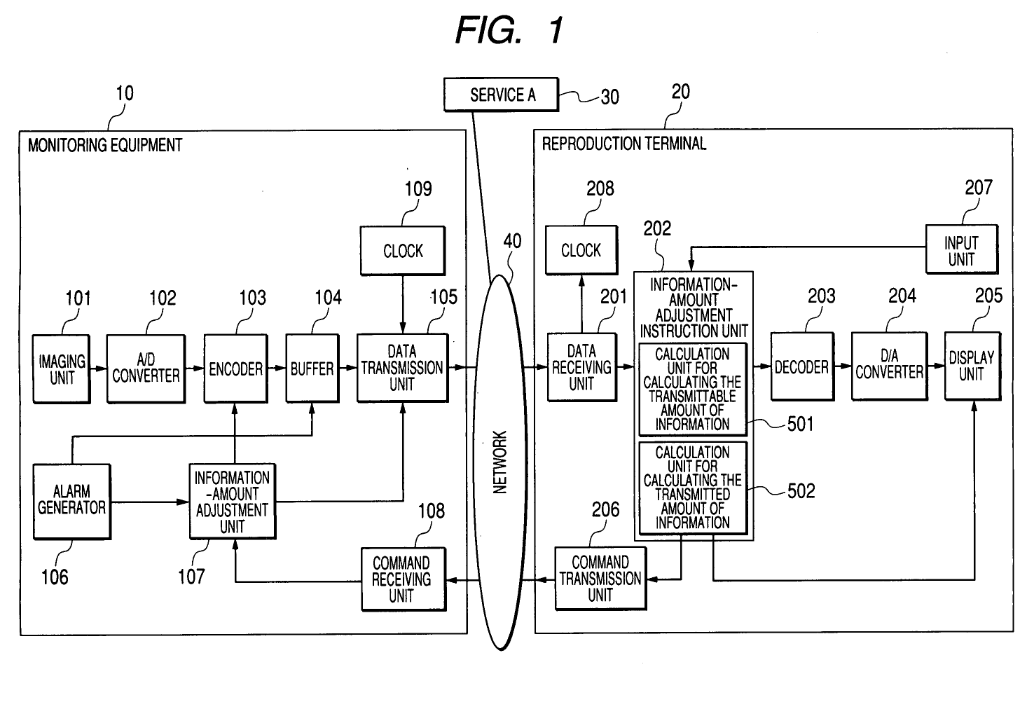

FIG. 1 is a block diagram illustrating a configuration of a network monitoring system according to an embodiment of the present invention. The network monitoring system of this embodiment transmits and receives monitoring information and control information through a network that shares a line with services of other communication systems. The network monitoring system operates, with an unoccupied band being kept remained, to reduce the amount of information consumed as the monitoring information and the control information in the network to a value smaller than the amount of information that is currently transmittable in the network.

In this network monitoring system, monitoring equipment 10 and a reproduction terminal 20 are connected through the network 40. The monitoring equipment 10 images a target to be monitored, then transmits monitoring information, including the imaged image data, to the destination reproduction terminal through the network, and thereby transmits and receives control information required to control the system. The reproduction terminal 20 includes units used for: receiving the monitoring information and the control information that are transmitted from the monitoring equipment 10 through the network; displaying image information of the monitoring information; and sending, to the network, control information required to control the network monitoring system. In addition, this network 40 is so configured that the line is also shared with a service A30, which is another communication system.

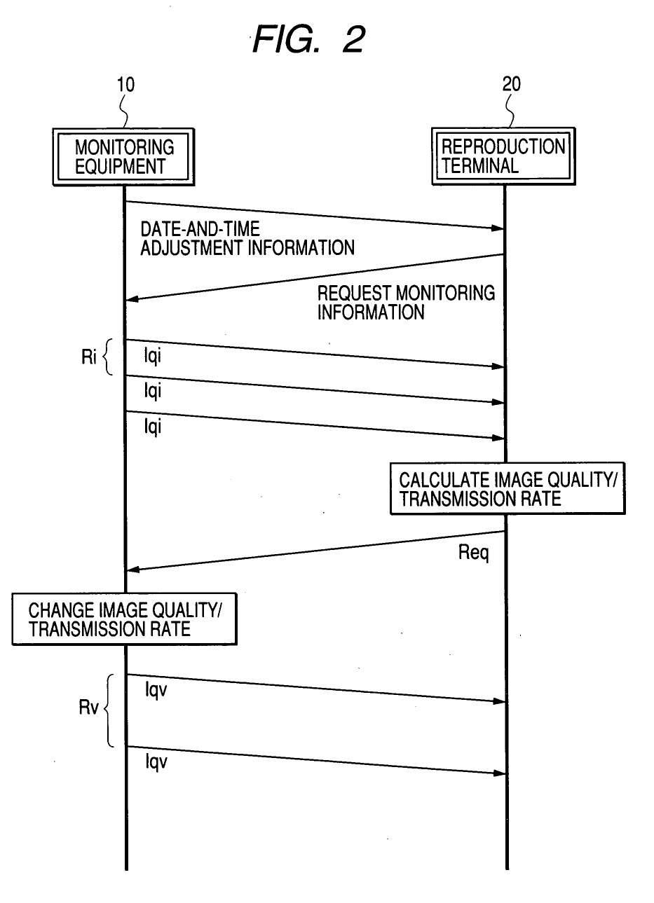

FIG. 2 is a sequence diagram illustrating information exchanges in the network monitoring system according to the embodiment of the present invention. The sequence diagram according to this embodiment illustrates, as an example, steps of transmitting/receiving monitoring information and control information, which are performed between the monitoring equipment 10 and the reproduction terminal 20.

How the network monitoring system shown in FIG. 1 operates will be outlined with reference to FIG. 2.

To begin with, the monitoring equipment 10 transmits to the reproduction terminal 20 information used to adjust the date and time. Then, on the basis of the information, the reproduction terminal 20 adjusts its date and time to that kept by the monitoring equipment 10. Next, by user's predetermined operation, or automatically, the reproduction terminal 20 transmits to the monitoring equipment 10 control information that requests monitoring information of a target to be monitored.

Upon receipt of the control information requesting the monitoring information, the monitoring equipment 10 transmits, according to a transmission interval Ri as a predetermined initial value, the monitoring information Iqi including image data that is encoded by use of a compression ratio, the number of images, the number of picture elements which are predetermined initial values. As shown in FIG. 3, the transmitted monitoring information consists of a header part including the transmitted date and time and the amount of information, and a data part including image data generated by imaging a target to be monitored.

Next, the reproduction terminal 20 calculates the time required for transmission Tt from the receive completed date and time Tr of the received monitoring information Iqi, and the transmitted date and time Ts included in the header part of the monitoring information Iqi. The following equation holds among Tr, Ts and Tt:
Tt=Tr−Ts

In addition, from the calculated time required for transmission Tt, and the amount of information Li included in the header part of the received monitoring information Iqi, it is possible to obtain the currently transmittable amount of information per unit time Ba. The following equation holds among Tt, Li and Ba:
Ba=Li/Tt

Moreover, the transmitted amount of information per unit time Bi of the monitoring information is calculated from the transmittable amount of information per unit time Ba, which has been calculated, and a predetermined occupation ratio R. The following equation holds among Ba, R and Bi:
Bi=Ba×R

Further, from the transmitted amount of information per unit time Bi of the monitoring information, which has been calculated, the reproduction terminal 20 determines the number of images to be encoded and a compression ratio for images included in the monitoring information. Then it issues to the monitoring equipment 10 a change request Req to change the number of images to be encoded, and the compression ratio, and/or the transmitted amount of information per unit time.

As soon as the monitoring equipment 10 receives the change request Req to change the number of images to be encoded and the compression ratio, and/or the transmitted amount of information per unit time, the monitoring equipment 10 controls the amount of information so as to satisfy monitoring information Iqv including the images encoded according to the number of images to be encoded and the compression ratio that have been requested, or so as to satisfy the transmitted amount of information per unit time that has been requested. Then, the monitoring equipment 10 transmits the information as monitoring information Ipv according to the transmission interval Rv.

Here, the transmittable amount of information Ba in the reproduction terminal 20 may be calculated from the time required RTT from a time of transmitting the control information having the predetermined amount of information Lc by the monitoring equipment 10, through sending back by the reproduction terminal 20 the received control information just as it is, until the monitoring equipment 10 completes the receipt of the control information that has been sent back. The following equation holds among Lc, RTT and Ba:
Ba=Lc×2/RTT

Incidentally, it is assumed that a period of time required by the reproduction terminal 20 to send back the received control signal can be ignored.

Additionally, in this embodiment, this time required RTT is transmitted from the monitoring equipment 10 to the reproduction terminal 20, and the reproduction terminal 20 then calculates the transmittable amount of information Ba. However, the monitoring equipment 10 may also be provided with a calculation unit for calculating the transmitted amount of information.

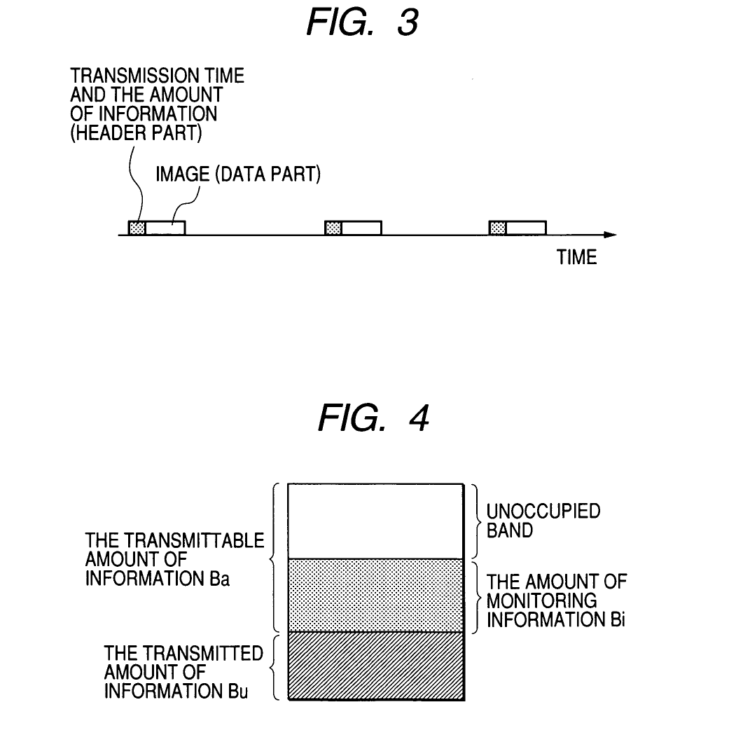

FIG. 4 is a diagram illustrating an occupation image of monitoring information in a network line according to an embodiment of the present invention. A state of the occupation will be described with reference to FIG. 4. In the network 40, the transmitted amount of information Bu is currently used by another communication system; and a remaining part is the transmittable amount of information Ba that is calculated by a calculation unit for calculating the transmittable amount of information.

Here, with the object of determining an occupation ratio of the monitoring information, on the basis of the occupation ratio R and the transmittable amount of information Ba that are predetermined, the calculation unit for calculating the transmitted amount of information calculates the transmitted amount of information per unit time Bi of the monitoring information. Then, an information-amount adjustment unit controls the amount of information so that the amount of information becomes the transmitted amount of information per unit time Bi that has been calculated. The transmitted amount of information per unit time Bi is used by the network monitoring system thereafter. Here, since an unoccupied band still exists, it is possible to transmit and receive information of another communication system by use of this unoccupied band.

In FIG. 1, the reproduction terminal 20 includes: a data receiving unit 201; an information-amount adjustment instruction unit 202; a decoder 203; a D/A converter 204; a display unit 205; a command transmission unit 206; an input unit 207; and a clock 208. The data receiving unit 201 is adapted to receive monitoring information from the monitoring equipment 10, and to add the receipt completed date and time to the monitoring information. The information-amount adjustment instruction unit 202 calculates the transmittable amount of information per the unit time, calculates the transmitted amount of information on the basis of the calculated transmittable amount of information per unit time and an occupation ratio, and generates a change request command to change the number of images to be encoded, and the compression ratio, and/or the transmitted amount of information per unit time, with the object of adjusting the amount of information for the monitoring equipment 10. The decoder 203 decodes compressed image data in the received monitoring information. The D/A converter 204 D/A converts the decoded digital image data into an analog image signal. The display unit 205 displays an analog image signal, and information such as an alarm. The command transmission unit 206 transmits a command generated by the information-amount adjustment instruction unit 202, and control information used for remote control. The input unit 207 receives limit values including an occupation ratio and the maximum compression ratio, which are coefficients used to control operation of the information-amount adjustment instruction unit 202. The clock 208 is updated by date-and-time adjustment information sent from the monitoring equipment 10.

In FIG. 1, the monitoring equipment 10 includes: an imaging unit 101 for imaging a target to be monitored; an A/D converter 102 for converting the imaged analog image signal into a digital image; an encoder 103 for encoding the digitized image data; a buffer 104; a data transmission unit 105; an alarm generator 106; an information-amount adjustment unit 107; a command receiving unit 108; and a clock. The buffer 104 accumulates monitoring information including compressed image data that has been encoded. The data transmission unit 105 reads out the monitoring information including the compressed image data, which is accumulated in the buffer 104, and then adds information such as the transmitted date and time to the monitoring information before transmitting the monitoring information. The alarm generator 106 generates an alarm signal if a change in the target to be monitored is equivalent to a predetermined reference value or more. The information-amount adjustment unit 107 changes the number of images to be encoded per unit time, or an encoding compression ratio, of the encoder 103, and/or the transmitted amount of information per unit time of the data transmission unit 105, to adjust the information amount of images to be transmitted to the network 40. The command receiving unit 108 is adapted to receive control information from the reproduction terminal 20. The clock 109 obtains the date and time used for date-and-time information and date-and-time adjustment information that are added to the monitoring information.

Here, the buffer 104 capable of accumulating monitoring information is usually formed of a write area, and an area that becomes transmittable after the completion of writing. When an alarm occurs, an area to which a write has been made, and from which no transmission has been performed, is write protected.

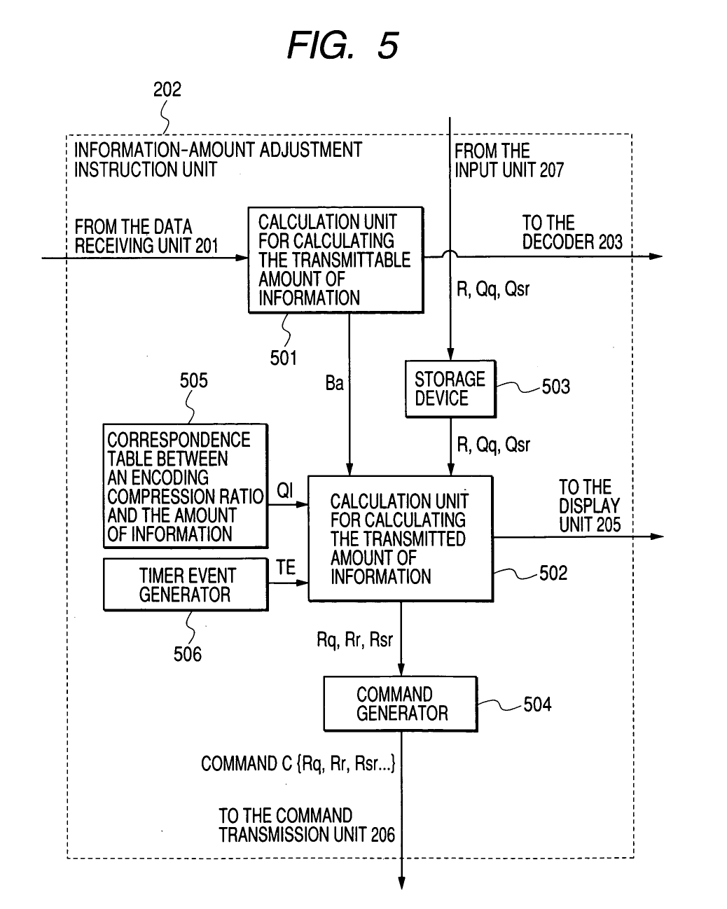

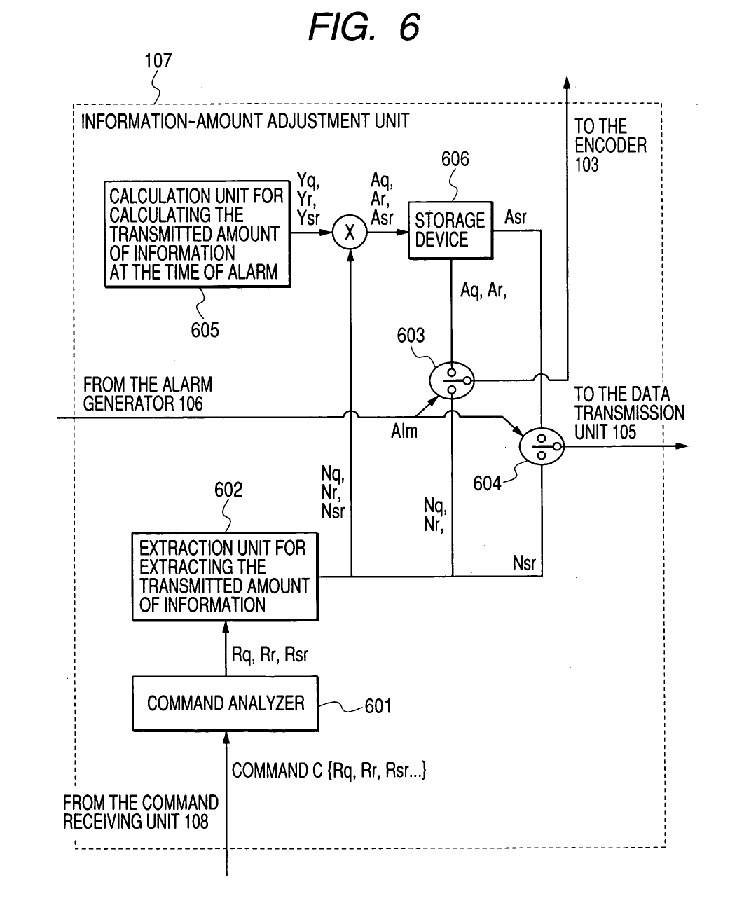

How the network monitoring system shown in FIG. 1 operates will be outlined with reference to FIGS. 5 and 6 below.

FIG. 5 is a block diagram illustrating a configuration of the information-amount adjustment instruction unit 202 according to an embodiment of the present invention. When a user input an occupation ratio R of the network 40, the maximum encoding compression ratio Qq, and the minimum transmitted amount of information per unit time Qsr through the input unit 207, the information-amount adjustment instruction unit 202 stores those values in the storage device 503. Here, the maximum encoding compression ratio Qq and the minimum transmitted amount of information per unit time Qsr are inputted to ensure the quality of monitoring information. They are limit values used to display an alarm if the encoding compression ratio becomes high, and the transmitted amount of information per unit time becomes low.

The information-amount adjustment instruction unit 202 receives from the data receiving unit 201 the monitoring information to which the receive completed date and time is added, and then passes the monitoring information to the calculation unit for calculating the transmittable amount of information. 501. The calculation unit for calculating the transmittable amount of information 501 calculates the length of time spent for the transmission by comparing the transmitted date and time included in the monitoring information with the receive completed date and time. The calculation unit 501 then obtains the transmittable amount of information per unit time Ba for the monitoring equipment 10 from the amount of information included in the monitoring information and the length of time spent for the transmission. Thereafter, the calculation unit 501 outputs the transmittable amount of information per unit time Ba to the calculation unit for calculating the transmitted amount of information 502.

A timer event notification TE of the timer event generator 506, which notifies that a fixed period of time has elapsed, triggers the calculation unit for calculating the transmitted amount of information 502 to start up. The calculation unit for calculating the transmitted amount of information 502 calculates the transmitted amount of information per unit time for the monitoring equipment 10 from the inputted transmittable amount of information per unit time Ba and the occupation ratio R. It is to be noted that this calculated value is treated as the transmitted amount of information per unit time Rsr in the description below.

In addition, the calculation unit for calculating the transmitted amount of information 502 performs the following steps: obtaining a plurality of amounts of information per image from an encoding compression ratio/information-amount correspondence table 505 (e.g., FIG. 9) showing an encoding compression ratio and the amount of information per image corresponding to the encoding compression ratio; calculating an integration value from the amounts of information per image thus obtained and the number of images to be encoded per unit time; from among combinations of integration values that are closer to a given value for the transmitted amount of information per unit time Rsr, determining a combination in which the encoding compression ratio becomes the lowest value; obtaining an encoding compression ratio and the number of images to be encoded at the time of selecting the combination, the values being treated as an encoding compression ratio Rq and the number of images to be encoded per unit time Rr respectively; and passing the obtained values to the command generator 504 together with the transmitted amount of information per unit time Rsr.

Upon receipt of the output from the calculation unit for calculating the transmitted amount of information 502, the command generator 504 generate an encoding information command formed of the number of images to be encoded Rr, the encoding compression ratio per unit time Rq, and the transmitted amount of information per unit time Rsr, and then passes the encoding information command to the command transmission unit 206.

The command transmission unit 206 transmits the generated command to the information-amount adjustment unit 107 through the command receiving unit 108 of the monitoring equipment 10.

Here, if any of the values calculated in the calculation unit for calculating the transmitted amount of information 502 exceeds the maximum encoding compression ratio Qq stored in the storage device 503, or if any of the values is below the minimum transmitted amount of information per unit time Qsr, a state in which the quality of the monitoring information cannot be guaranteed is displayed using the display unit 205 to notify the user of the state.

In this embodiment, a combination at the time of the minimum encoding compression ratio is determined so as to utilize an image with the highest possible quality. However, the present invention is not limited to this. For example, a combination at the time of the maximum number of images to be encoded may also be determined. If monitored image moves fast, and therefore, it is necessary to increase the number of images to be encoded per unit time, this combination at the time of the maximum number of images to be encoded is suitable.

FIG. 6 is a block diagram illustrating a configuration of the information-amount adjustment unit 107 according to an embodiment of the present invention. The information-amount adjustment unit 107 receives through the command receiving unit 108 the encoding information command formed of the number of images to be encoded per unit time Rr, the encoding compression ratio Rq, and the transmitted amount of information per unit time Rsr, and then analyzes contents of the command by the command analyzer 601. After that, the information-amount adjustment unit 107 outputs, to an extraction unit for extracting the transmitted amount of information 602, the number of images to be encoded per unit time Rr, the encoding compression ratio Rq, and the transmitted amount of information per unit time Rsr, which are included in the encoding information command.

During normal operation, the extraction unit for extracting the transmitted amount of information 602 integrates scaling factors Xr, Xq, and Xsr, which are specified coefficients, for the number of images to be encoded per unit time Rr, the encoding compression ratio Rq, and the transmitted amount of information per unit time Rsr, respectively. Then, as the number of images to be encoded for normal operation Nr and an encoding compression ratio for normal operation Nq, the extraction unit for extracting the transmitted amount of information 602 outputs the result to the encoder 103 through a switch 603. In addition, the extraction unit for extracting the transmitted amount of information 602 outputs the transmitted amount of information per unit time Nsr, which has been extracted, to the data transmission unit 105 through a switch 604.

Here, according to whether or not an alarm signal Alm is sent from the alarm generator 106, the switch 603 and switch 604 are devised to select a signal to be output to the encoder 103 and a signal to be output to the data transmission unit 105, respectively. If no alarm signal Alm is sent, the switches 603, 604 are devised to select a signal from the extraction unit for extracting the transmitted amount of information 602.

Moreover, the calculation unit for calculating the transmitted amount of information at the time of alarm 605 integrates the scaling factors Yr, Yq, and Ysr, which are specified coefficients, for the number of images to be encoded for normal operation Nr, the encoding compression ratio for normal operation Nq, and the transmitted amount of information per unit time for normal operation Nsr, respectively, which are output from the extraction unit for extracting the number of images to be encoded, a compression ratio, and the transmission amount of information 602. The calculation unit for calculating the transmitted amount of information at the time of alarm 605 then stores the integrated values in the storage device 606 as the number of images to be encoded at the time of alarm Ar, an encoding compression ratio at the time of alarm Aq, and the transmitted amount of information per unit time at the time of alarm Asr.

When an alarm occurs, that is to say, when receiving an alarm signal Alm from the alarm generator 106, the information-amount adjustment instruction unit 107 outputs the number of images to be encoded at the time of alarm Ar and the encoding compression ratio at the time of alarm Aq, which are stored in the storage device 606, to the encoder 103 through the switch 603. In addition, the information-amount adjustment instruction unit 107 outputs the transmitted amount of information per unit time at the time of alarm Asr, stored in the storage device 606, to the data transmission unit 105 through the switch 604.

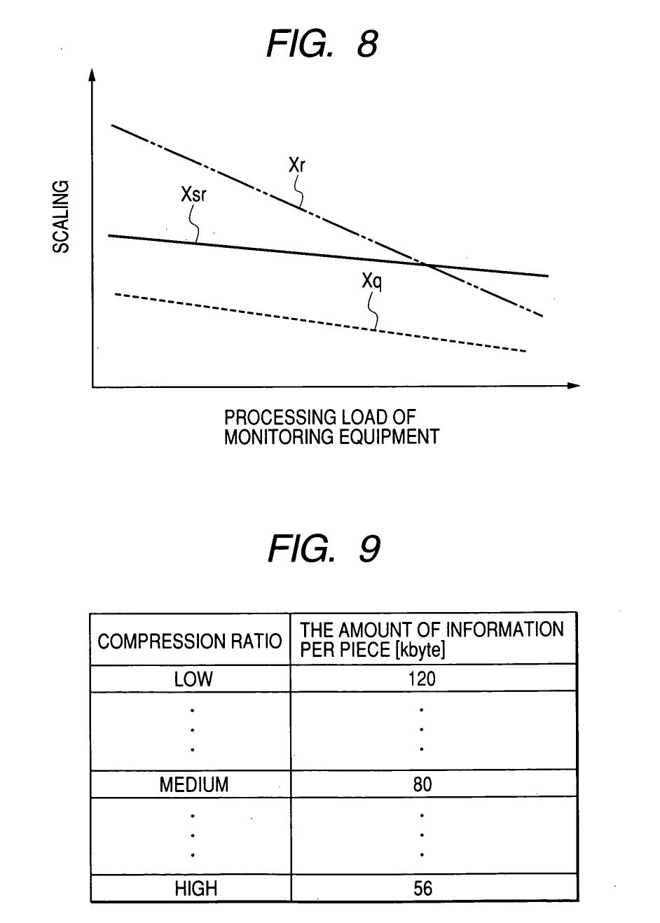

Here, as shown in FIG. 8, each of the scaling factors Xr, Xq, and Xsr used in the extraction unit for extracting the transmitted amount of information 602 may also be changed in accordance with to a state of a processing load of the monitoring equipment 10, or the like. In this embodiment, the scaling factors are configured to become smaller with the increase in processing load of the monitoring equipment 10. To be more specific, when the processing load is large relative to a change in system state of the monitoring equipment 10, the number of images to be encoded Nr, the encoding compression ratio for normal operation Nq, the transmitted amount of information per unit time for normal operation Ns are made small to reduce the processing load. Moreover, a tilt of a change in scaling factor corresponding to a processing load may also be changed for each of the number of images to be encoded Nr, the encoding compression ratio for normal operation Nq, and the transmitted amount of information per unit time for normal operation Ns. This makes it possible to flexibly cope with even a change in system state that cannot be easily detected from the reproduction terminal 20.

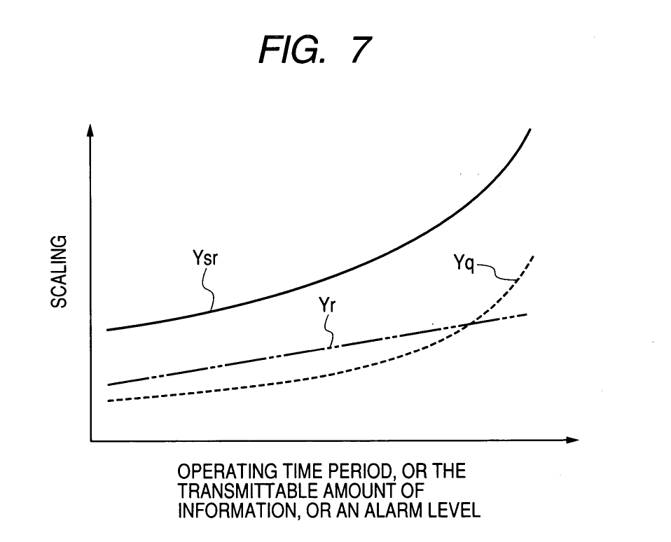

In addition, as shown in FIG. 7, each of the scaling factors Yr, Yq, and Ysr used in the calculation unit for calculating the transmitted amount of information at the time of alarm 605 may also be changed in accordance with the operating time period, or the transmittable amount of information, of the network monitoring system in question, or in accordance with an alarm level set by a user, or the like. For example, in this embodiment, the scaling factors are configured to become larger with the increase in the transmittable amount of information. To be more specific, when the transmittable amount of information is large, even if the transmitted amount of information at the time of alarm Asr is made large, the absolute amount required for a remaining band is ensured. Accordingly, the scaling factors can be made large. In this case, the amount of occupation in the network can be optimized in response to the quality of monitoring information required when an alarm occurs. Therefore, the efficient use of the network can be expected.

The amount of encoded information per unit time for normal operation Ni and the transmitted amount of information per unit time for normal operation Nsr, which can be determined by the number of images to be encoded for normal operation Nr and the encoding compression ratio for normal operation Nq, are required to satisfy the following condition:

The amount of encoded information for normal operation Ni≦the transmitted amount of information for normal operation Nsr

By use of this condition, when transmitting monitoring information during normal operation, the monitoring equipment 10 can transmit monitoring information that is newer than the monitoring information that has been transmitted last time. When the transmitted amount of information for normal operation Nsr is smaller than the minimum transmitted amount of information per unit time Qsr, and as a result, even if the undermentioned condition cannot be satisfied, the monitoring information is always replaced with new one by use of the monitoring information buffer 104, making it possible to transmit the latest information.

The condition used for normal operation is not given to the amount of encoded information per unit time at the time of alarm Ai and the transmitted amount of information per unit time at the time of alarm Asr, which can be determined by the number of images to be encoded at the time of alarm Ar and the encoding compression ratio at the time of alarm Aq.

If the amount of encoded information at the time of alarm Ai and the transmitted amount of information per unit time at the time of alarm Asr satisfy the following condition, the speed at which the monitoring information is stored in the monitoring information buffer 104 exceeds the speed at which the monitoring information is transmitted from the data transmission unit 105. In this case, since the monitoring information that is not transmitted is held in the buffer 104 until the completion of the transmission, it is possible to keep the quality of the monitoring information.

The amount of encoded information at the time of alarm Ai>the transmitted amount of information at the time of alarm Asr

In this embodiment, although the information-amount adjustment instruction unit 202 is provided in the reproduction terminal 20, this unit may also be provided in the monitoring equipment 10.

In addition, in the calculation unit for calculating the transmitted amount of information 502, the encoding compression ratio Rq, the number of images to be encoded per unit time Rq, and the transmitted amount of information per unit time Rsr may also be selectively calculated on the basis of a ratio of the maximum transmittable amount of information, which has been obtained last time as a result of calculating the encoding compression ratio Rq, the number of images to be encoded per unit time Rq, and the transmitted amount of information per unit time Rsr, to the maximum transmittable amount of information calculated this time. For example, if the amount of change is small, the values calculated last time are used instead of calculating again the encoding compression ratio Rq, the number of images to be encoded per unit time Rq, and the transmitted amount of information per unit time Rsr. This makes it possible to reduce a processing load.

Although this embodiment described the case where one set of monitoring equipment is connected, even a case where two sets of monitoring equipment or more are connected is included in the category of the present invention. Further, the present invention can also be applied to a case where a plurality of other communication systems are connected to the network.

According to the embodiment of the present invention, in the network monitoring system, the transmitted amount of monitoring information is controlled first by calculating the transmittable amount of information per unit time from the amount of monitoring information and the length of time spent for the transmission, and then by changing the transmitted amount of information per unit time, and an encoding compression ratio, of the monitoring information on the basis of the calculated transmittable amount of information and a predetermined occupation ratio. As a result, an unoccupied band is provided in the network line, making it possible to improve the quality of communications of the other communication systems.

In addition, in the event of an emergency, including a case where an alarm occurs, it is possible to transmit monitoring information with the high image quality, while keeping a proper occupation ratio of the monitoring information in the network line, by changing the number of images per unit time, and a compression ratio, of monitoring information, and an occupation ratio of the monitoring information in the network line according to a occupation ratio and coefficients, which are predetermined, for a given period of time after the occurrence of the alarm, and by accumulating in the buffer the monitoring information, the number of images of which is increased by decreasing the compression ratio, and then by controlling the amount of read information. This makes it possible to improve the quality of monitoring information in the event of an emergency.

According to the present invention, it is possible to obtain a network monitoring system, a reproduction terminal, and a monitoring terminal, in which the quality of communications of the other communication systems can be improved. In addition, according to the present invention, it is possible to obtain a network monitoring system in which monitoring information with high image quality can be transmitted while keeping a proper occupation ratio of the monitoring information in a network line.

1. A network monitoring system that shares a network line with at least another communication system, the network monitoring system comprising:
monitoring equipment including:
an encoder for compressing image data;
a data transmission unit for transmitting monitoring information including compressed image data through the network line; and
an information-amount adjustment unit for adjusting an amount of information per unit time of the monitoring information to be transmitted from the data transmission unit;
a reproduction terminal including:
a data receiving unit adapted to receive the monitoring information transmitted from the monitoring equipment through the network line; and
a decoder for decompressing compressed image data included in the monitoring information;
a calculation unit for calculating the transmittable amount of information which calculates the transmittable amount of information per unit time of the network line; and
a calculation unit for calculating the transmitted amount of information which calculates the transmitted amount of information per unit time of the monitoring information to be transmitted on the basis of a predetermined occupation ratio in order to determine a ratio of the monitoring information to the calculated transmittable amount of information;
wherein said information-amount adjustment unit is controlled on the basis of the transmitted amount of information per unit time which has been calculated by the calculation unit for calculating the transmitted amount of information.

2. A network monitoring system according to claim 1, wherein said information-amount adjustment unit controls the encoder so that the number of images per unit time, the number of picture elements or a compression ratio included in the monitoring information, or their combination may be changed, and thereby the amount of information per unit time of the monitoring information to be transmitted from the data transmission unit is adjusted.

3. A network monitoring system that shares a network line with at least another communication system, said network monitoring system comprising:
monitoring equipment including:
an encoder for compressing image data;
a buffer for accumulating monitoring information including compressed image data compressed by the encoder;
a data transmission unit which reads out the monitoring information accumulated in the buffer, and then transmits through the network line the monitoring information including compressed image data; and
an information-amount adjustment unit for adjusting an amount of information per unit time of the monitoring information to be transmitted from the data transmission unit;
a reproduction terminal including:
a data receiving unit adapted to receive the monitoring information transmitted from the monitoring equipment through the network line; and
a decoder for decompressing compressed image data included in the monitoring information;
a calculation unit for calculating the transmittable amount of information which calculates the transmittable amount of information per unit time of the network line; and
a calculation unit for calculating the transmitted amount of information which calculates the transmitted amount of information per unit time of the monitoring information to be transmitted on the basis of a predetermined occupation ratio in order to determine a ratio of the monitoring information to the calculated transmittable amount of information;
wherein said information-amount adjustment unit is controlled on the basis of the transmitted amount of information per unit time which has been calculated by the calculation unit for calculating the transmitted amount of information.

4. A network monitoring system according to claim 3, wherein said information-amount adjustment unit controls the encoder so that an image compression ratio per unit time of images included in monitoring information becomes low to increase the number of images, and also controls the data transmission unit so that the amount of information per unit time at the time of reading out images included in the monitoring information accumulated in the buffer may be controlled to adjust the amount of information per unit time of the monitoring information to be transmitted from the data transmission unit.

5. A network monitoring system according to claim 1, wherein:
the monitoring equipment and the reproduction terminal is each provided with an information transmitting and receiving unit that transmits and receives, between the monitoring equipment and the reproduction terminal, control information used for controlling said network monitoring system;
said reproduction terminal is further provided with the calculation unit for calculating the transmittable amount of information and the calculation unit for calculating the transmitted amount of information; and
said information transmitting and receiving unit transmits, to the monitoring equipment, information about the transmitted amount of information per unit time that has been calculated by the calculation unit for calculating the transmitted amount of information in the reproduction terminal, and then the monitoring equipment controls the information-amount adjustment unit on the basis of the received information about the transmitted amount of information per unit time.

6. A network monitoring system according to claim 5, further comprising:
a unit for achieving date-and-time matching between the reproduction terminal and the monitoring equipment;
wherein said calculation unit for calculating the transmittable amount of information, which is provided in the reproduction terminal, calculates the transmittable amount of information per unit time at the time of transmission by the monitoring equipment through the network line, from the transmitted date and time that has been added by the monitoring equipment to each monitoring information to be transmitted by a specified unit of the amount of information, and from the receive completed date and time of the monitoring information received by the reproduction terminal, and the amount of received information.

7. A network monitoring system according to claim 5, wherein:
said calculation unit for calculating the transmittable amount of information, which is provided in the reproduction terminal, calculates a transmittable amount of information per unit time at the time of transmission by the monitoring equipment through the network line, from the length of time spent from the transmission of the control information until the receipt of the control information, and from the amount of information.

8. A network monitoring system according to claim 1, further comprising:
a timer generator; wherein:
every time a given period of time elapses, said calculation unit for calculating the transmittable amount of information calculates the transmittable amount of information per unit time at the time of transmission through the network line; and then the information-amount adjustment unit is controlled on the basis of a transmitted amount of information per unit time, which has been calculated by the calculation unit for calculating the transmitted amount of information from the calculated transmittable amount of information per the unit time and the occupation ratio.

9. A network monitoring system according to claim 8, wherein:
said calculation unit for calculating the transmitted amount of information performs the steps of: accumulating a plurality of pieces of information about the transmittable amount of information per unit time sent from the calculation unit for calculating the transmittable amount of information; calculating a degree of change in the plurality of pieces of information about the transmittable amount of information per unit time; every time a given period of time elapses, calculating and accumulating the transmittable amount of information per unit time; and adjusting an amount of monitoring information on the basis of a ratio of the latest transmittable amount of information calculated this time to the transmittable amount of information that has been calculated and accumulated last time.

10. A network monitoring system according to claim 2, wherein said monitoring equipment has a plurality of operation modes, changes the occupation ratio in accordance with the operation modes, and thereby adjusts the amount of information per unit time of the monitoring information to be transmitted from the data transmission unit.

11. A network monitoring system according to claim 10, further comprising:
an alarm generator for generating an alarm if an abnormal condition of a target to be monitored is detected, wherein:
the alarm generator classifies the abnormal condition into a plurality of levels; and
one of the operation modes is selected in accordance with one of the levels, and the occupation ratio is changed in accordance with the selected operation mode, whereby the amount of information per unit time of the monitoring information to be transmitted from the data transmission unit is adjusted.

12. A network monitoring system according to claim 3, further comprising:
an alarm generator for generating an alarm if an abnormal condition of a target to be monitored is detected; wherein:
when an alarm occurs, image monitoring information for a given period of time from the occurrence of the alarm is stored in the buffer for accumulating monitoring information; the amount of information per unit time of the monitoring information to be read out from the buffer is controlled so that a predetermined occupation ratio may be kept unchanged; the amount of information per unit time of the monitoring information to be transmitted from the data transmission unit is adjusted; and all the monitoring information accumulated in the buffer is transmitted.

13. A network monitoring system according to claim 10, wherein:
when an alarm occurs, an amount of information per unit time of the monitoring information to be read out from the buffer is controlled; and during normal operation, the number of images per unit time, the number of picture elements., a compression rate, or their combination is changed.

14. A reproduction terminal or a monitoring terminal included in a network monitoring system that shares a network line with at least another communication system,
said monitoring equipment transmitting monitoring information including compressed image data through the network line; and
said reproduction terminal receiving the monitoring information transmitted from the monitoring equipment through the network line, and decompressing the compressed image data included in the monitoring information,
said reproduction terminal or said monitoring terminal comprising:
a calculation unit for calculating the transmittable amount of information which calculates the transmittable amount of information per unit time of the network line; and
a calculation unit for calculating the transmitted amount of information which calculates the transmitted amount of information per unit time of the monitoring information to be transmitted on the basis of an occupation ratio that has been predetermined, in order to determine a ratio of the monitoring information to the calculated transmittable amount of information;
wherein the transmitted amount of information per unit time of the monitoring information to be transmitted from the monitoring equipment can be controlled on the basis of the transmitted amount of information per unit time that has been calculated by the calculation unit for calculating the transmitted amount of information.
